(19) United States
(12) Patent Application Publication
(10) Pub. No.: US 2012/0048304 A1
(43) Pub. Date: Mar. 1, 2012

(54) SUPERCRITICAL DRYING METHOD AND SUPERCRITICAL DRYING SYSTEM

(76) Inventors: Yukiko KITAJIMA, Komatsu-Shi (JP); Hiroshi TOMITA, Yokohama-Shi (JP); Hidekazu HAYASHI, Yokohama-Shi (JP); Hisashi OKUCHI, Yokohama-Shi (JP); Yohei SATO, Yokohama-Shi (JP)

(21) Appl. No.: 13/029,776

(22) Filed: Feb. 17, 2011

(30) Foreign Application Priority Data
Aug. 30, 2010 (JP) 2010-192272

(51) Int. Cl. B08B 3/00

(52) U.S. Cl. 134/30; 134/94.1

(57) ABSTRACT

According to an embodiment, a supercritical drying method includes: introducing a semiconductor substrate of which a surface is wet with a supercritical displacement solvent into a chamber; supplying a first supercritical fluid being based on first carbon dioxide to the chamber; supplying a second supercritical fluid which is based on second carbon dioxide to the chamber, after the supplying of the first supercritical fluid; and lowering an inside pressure of the chamber to gasify the second supercritical fluid and to discharge the gasified second supercritical fluid from the chamber. The first carbon dioxide is generated by recovering and recycling the carbon dioxide discharged from the chamber. The second carbon dioxide contains no supercritical displacement solvent or contains the supercritical displacement solvent in a concentration lower than that in the first carbon dioxide.

### CROSS REFERENCE TO RELATED APPLICATION

This application is based upon and claims benefit of priority from the Japanese Patent Application No. 2010-192272, filed on Aug. 30, 2010, the entire contents of which are incorporated herein by reference.

### FIELD

Embodiments described herein relate generally to a supercritical drying method and a supercritical drying system.

### BACKGROUND

Processes of manufacturing a semiconductor device include a lithography process, an etching process, and an ion implantation process. After completion of each process and before starting of the subsequent process, cleaning and drying are performed to remove impurities or residues remaining on the surface of a semiconductor substrate, thereby cleaning the surface of the semiconductor substrate.

Carbonate supercritical drying is known as one of the methods of drying a semiconductor substrate. For example, this is a method for drying a semiconductor substrate by supplying supercritical carbon dioxide (supercritical CO₂) to the surface of the semiconductor substrate wet with isopropyl alcohol (IPA) serving as a rinse agent within a chamber, dissolving the IPA on the surface of the semiconductor substrate into the supercritical CO₂ to remove the IPA from the semiconductor substrate, returning the pressure inside the chamber to the atmospheric pressure, and gasifying and purging the supercritical CO₂.

However, this involves a problem in that particles are generated since IPA mist remaining inside the chamber condenses and is re-adsorbed onto the semiconductor substrate, when the pressure inside the chamber is lowered so that the carbon dioxide may be changed in phase from the supercritical state to the gas phase, as described above.

Since a large amount of carbon dioxide is used in the carbonate supercritical drying, the carbon dioxide is required to be recovered, recycled, and reused in terms of cost and environment. In regard to the performance of a carbon dioxide recovery and recycling system according to the related art, IPA dissolved in the supercritical CO₂ may not be sufficiently removed and thus the carbon dioxide may not be recycled. The above-mentioned particles were generated due to the IPA mist. Further, using the recycled carbon dioxide in which the IPA remains gives rise to a problem in that reduction of particles is obstructed.

### BRIEF DESCRIPTION OF THE DRAWINGS

FIG. 1 is a state diagram illustrating a relationship among a pressure, a temperature, and a phase state of a material;

FIG. 2 is a graph illustrating a relationship between a supercritical drying process and the number of particles;

FIG. 3 is a diagram illustrating a relationship between an IPA concentration in carbon dioxide and a particle distribution;

FIG. 4 is a schematic diagram illustrating the configuration of a supercritical drying system according to a first embodiment of the invention;

FIG. 5 is a flowchart for explaining a supercritical drying method according to the first embodiment of the invention;

FIG. 6 is a graph illustrating a pressure variation inside a chamber;

FIG. 7 is a schematic diagram illustrating the configuration of a supercritical drying system according to a second embodiment of the invention;

FIG. 8 is a flowchart for explaining a supercritical drying method according to the second embodiment of the invention;

FIG. 9 is a graph illustrating a pressure variation inside a chamber; and

FIG. 10 is a schematic diagram illustrating the configuration of a supercritical spectroscopic cell.

### DETAILED DESCRIPTION

According to an embodiment, a supercritical drying method includes: introducing a semiconductor substrate of which a surface is wet with a supercritical displacement solvent into a chamber; supplying a first supercritical fluid being based on first carbon dioxide to the chamber; supplying a second supercritical fluid being based on a second carbon dioxide to the chamber, after the supplying of the first supercritical fluid; and discharging the second supercritical fluid gasified by lowering of a pressure inside the chamber. The first carbon dioxide is generated by recovering and recycling the carbon dioxide discharged from the chamber. The second carbon dioxide is a new product of carbon dioxide that never contains the supercritical displacement solvent. Alternatively, the second carbon dioxide is obtained by recycling recovered carbon dioxide to the extent such that the second carbon dioxide may contain the supercritical displacement solvent in a concentration lower than that in the first carbon dioxide and particles on the semiconductor substrate that are generated due to a solvent mist are not problematic.

Hereinafter, embodiments of the invention will be described with reference to the drawings.

### First Embodiment

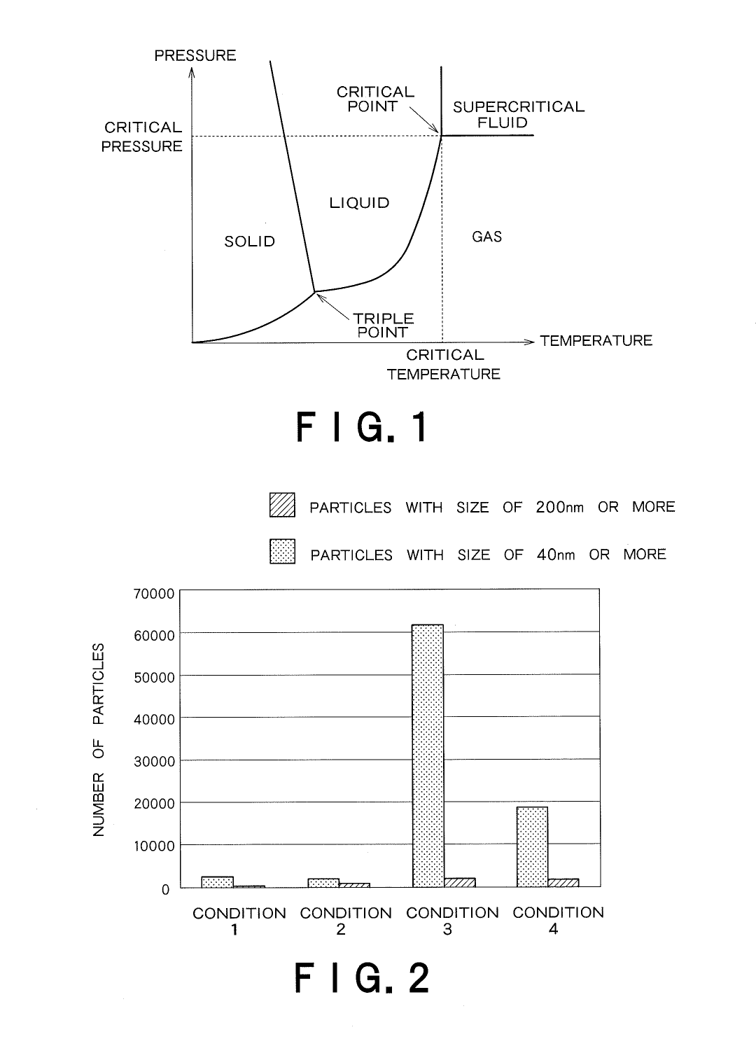

Supercritical drying will first be described. FIG. 1 is a state diagram illustrating a relationship among a pressure, a temperature, and a phase state of substance. A functional substance of a supercritical fluid used in the supercritical drying has three existing phases: a gas phase (gas), a liquid phase (liquid), and a solid phase (solid) that are collectively called three states of matter.

As shown in FIG. 1, the three phases are demarcated by a vapor pressure curve (gas-phase equilibrium line) indicating the boundary between the gas phase and the liquid phase, a sublimation curve indicating the boundary between the gas phase and the solid phase, and a melting curve indicating the boundary between the solid phase and the liquid phase. A point at which the three phases overlap with each other is called a triple point. When the vapor pressure curve extends from the triple point toward the high temperature side, the vapor pressure curve reaches a critical point at which the gas phase and the liquid phase coexist. At the critical point, the density of the gas phase is the same as that of the liquid phase, and thus the phase boundary in the state the gas-liquid coexistence is lost.

The gas phase and the liquid phase are no longer identified from each other at temperature and pressure higher than the critical point, and a substance beyond its critical point becomes a supercritical fluid. The supercritical fluid is a fluid condensed to high density at temperature higher than a critical point. The supercritical fluid is similar to a gas from the viewpoint in that the spreading force of solvent molecules is dominant, whereas the supercritical fluid is similar to a liquid from the viewpoint in that an influence of the cohesive force of molecules cannot be ignored. Therefore, the supercritical fluid has the property of dissolving various kinds of substances therein.

Moreover, the supercritical fluid has the property of easily infiltrating into a minute structure since the supercritical fluid has the infiltration property much higher than that of a liquid.

Furthermore, the supercritical fluid can be dried without collapsing a minute structure by directly transiting in the phase state from the supercritical state to the gas phase so that there is no gas-liquid interface, that is, a capillary force (surface tension) is not applied. When the supercritical drying is performed, the substrate is dried using the supercritical state of the supercritical fluid.

Examples of the supercritical fluid used in the supercritical drying include carbon dioxide, ethanol, methanol, propanol, butanol, methane, ethane, propane, water, ammonia, ethylene, and fluoromethane.

In particular, treatment using carbon dioxide is easy because its critical temperature is 31.1° C., its critical pressure is about 7.4 MPa, and carbon dioxide exists at relatively low temperature and pressure. In this embodiment, carbonate supercritical drying using carbon dioxide will be described.

In the carbonate supercritical drying, chemical washing, pure water rinsing, and supercritical displacement solvent rinsing are first performed on a semiconductor substrate inside a washing chamber. After that, the semiconductor substrate is introduced into a carbonate supercritical chamber. At this time, the semiconductor substrate is moved in a state where the surface of the semiconductor substrate is wet (dipped) with a supercritical displacement solvent. As the supercritical displacement solvent, alcohols that can be easily displaced by carbon dioxide being in a supercritical state (supercritical CO₂) are used, and isopropyl alcohol (IPA) is particularly used in this embodiment. Alcohols (lower alcohol or higher alcohol), fluorinated alcohol, chlorofluorocarbon (CFC), hydrofluorocarbon (HCFC), hydrofluoroether (HFE), or perfluoro carbon (PFC) can be used as the supercritical displacement solvent. Moreover, a substance formed from halogenated aldehydes, halogenated ketones, halogenated diketones, halogenated esters, or halogenated silanes can be used as the supercritical displacement solvent.

Drying was performed on a semiconductor substrate under four conditions described below, and then the number of particles with a size equal to or greater than 200 nm and the number of particles with a size equal to or greater than 40 nm on the semiconductor substrate after drying were examined.

TABLE 1

| | |
|---|---|
| condition 1 | non-treatment (semiconductor substrate was not |
| | dipped in IPA and remains in chamber without |
| | performing carbonate supercritical drying) |
| condition 2 | semiconductor substrate was not dipped in IPA |
| | and carbonate supercritical drying was performed |
| | for 30 minutes |
| condition 3 | semiconductor substrate was dipped in IPA and |
| | carbonate supercritical drying was performed for |
| | 20 minutes |
| condition 4 | semiconductor substrate was dipped in IPA and |
| | carbonate supercritical drying was performed for |
| | 40 minutes |

The number of particles on the semiconductor substrate subjected to the drying under each condition was shown in FIG. 2. From the fact that the number of particles under condition 1 is nearly the same as the number of particles under condition 2, it can be understood that the contamination of the chamber or the carbonate supercritical drying process itself is not the factor in generation of the particles. That is, since the number of particles in liquefied carbon dioxide or the number of particles generated from a pump, a valve, or the like used to pressurize the liquefied carbon dioxide into the supercritical drying state is almost the same as that on the substrate not subjected to the supercritical drying under condition 1, it can be understood that such particles are not in a problematic level in terms of number.

As compared with conditions 1 and 2, the number of particles (particularly, the number of fine particles with a size equal to or less than 100 nm) is considerably increased under condition 3. Moreover, as compared with condition 3, the number of fine particles is decreased to about ⅓ under condition 4. Accordingly, it can be understood that the number of particles is considerably increased when the IPA is used as a rinse liquid and is introduced under a carbonate supercritical state. Moreover, it can be understood that the number of particles can be reduced by purging (removing or purifying) the IPA in the chamber using the supercritical CO₂ according to condition 4 in which the carbonate supercritical state is maintained for a relatively long time.

That is, the examination result clearly shows that the particles are generated on the semiconductor substrate subjected to the carbonate supercritical drying, in such a way that the IPA used as the supercritical displacement solvent remains in the form of a liquid mist in the carbonate supercritical fluid inside the supercritical drying chamber and thus is not sufficiently purged from the carbonate supercritical chamber, and the IPA remaining in the chamber condenses on the substrate when the pressure is lowered to the critical pressure or less, at which the carbonate supercritical state is changed to the carbonate gas state. Accordingly, in order to reduce the number of particles generated, it is necessary to reduce a concentration of IPA being in the carbonate supercritical fluid in the chamber. It is achieved by not allowing the IPA dissolved in the carbonate supercritical fluid to remain on the substrate or in the chamber but discharging it from the chamber maintained in the carbonate supercritical state while maintaining the substrate wet with the IPA in the carbonate supercritical state.

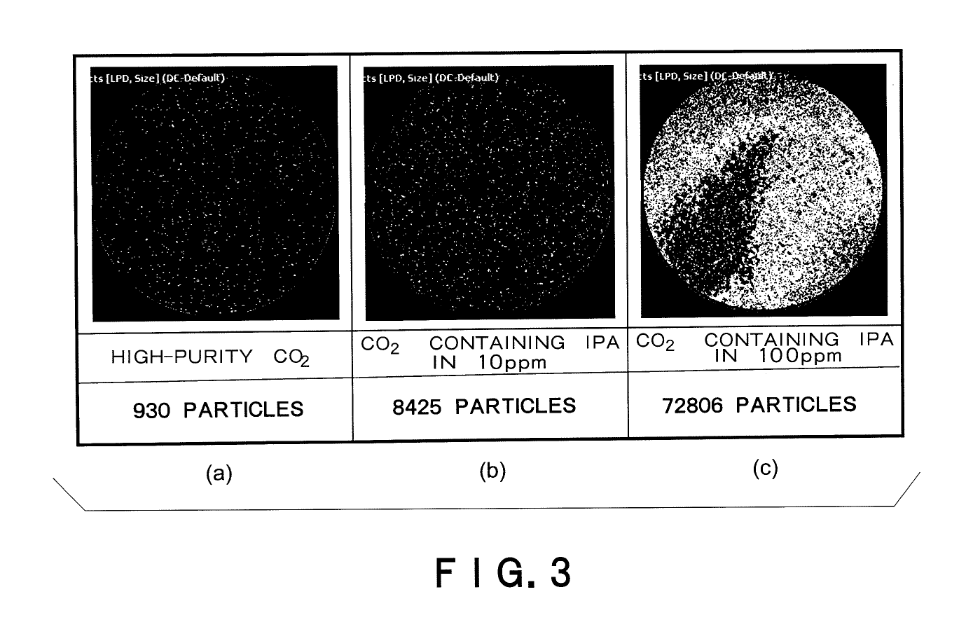

In order to verify a model of the invention in which the IPA remaining in the chamber condenses on the substrate and thus turns into particles to be detected, FIGS. 3A to 3C show distributions of the particles with sizes equal to or greater than nm on a semiconductor substrate when the carbonate supercritical drying is performed using various CO₂ containing different amounts of IPA. FIG. 3(a) shows the case in which high purity CO₂ containing nearly no IPA is used, FIG. 3(b) shows the case in which CO₂ containing the IPA in a concentration of 10 ppm is used, and FIG. 3(c) is the case in which CO₂ containing the IPA in a concentration of 100 ppm is used.

When the high purity CO₂ was used (FIG. 3(a)), the number of particles on the substrate was 930. When CO₂ containing the IPA in a concentration of 10 ppm was used (FIG. 3(b)), the number of particles on the substrate was 8425.

When CO₂ containing the IPA in a concentration of 100 ppm was used (FIG. 3(c)), the number of particles on the substrate was 72806.

As a consequence, it is considered that the IPA concentration (CO₂ supplied to the chamber) in the chamber must be at most 1 ppm or less in order to suppress the number of particles to the extent as many as the number of particles generated when the high purity CO₂ is used. However, the above result relates to the case in which the size of the measured particles is 40 nm or more. Moreover, when defects with a minute size are targets, for example, when the size of the target particle is 30 nm or more, it is, of course, required to reduce the IPA concentration up to the concentration far lower than 1 ppm.

When the IPA is used as the supercritical displacement solvent, the IPA concentration of CO₂ discharged from the chamber is tens of thousands ppm. When such CO₂ is recovered and recycled in a recovery and recycling system according to the related art, it is difficult to lower the IPA concentration of the recycled CO₂ to 10 ppm or less in terms of technique and cost. The carbonate supercritical drying using the recycled CO₂ with an IPA concentration of 10 ppm or more results in generation of many particles. In this embodiment, therefore, by alternately using the recycled CO₂ and the high purity CO₂, the usage amount of high purity CO₂ is suppressed, which leads to reduction in cost and in the number of particles generated on the semiconductor substrate.

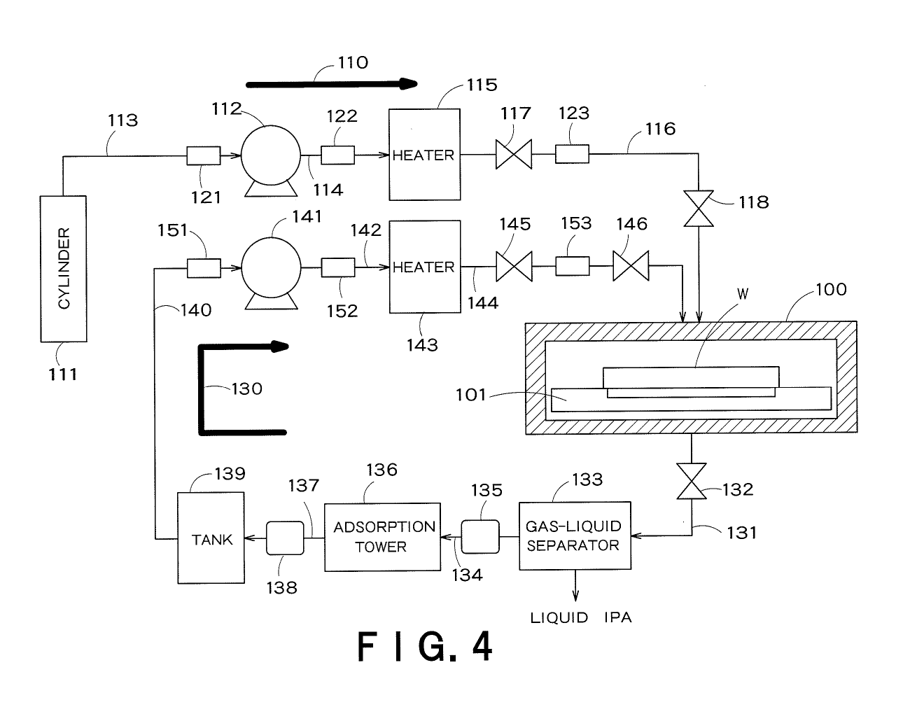

FIG. 4 is a schematic diagram illustrating the configuration of a supercritical drying system according to the first embodiment of the invention. The supercritical drying system includes a chamber 100, a supply line 110 supplying high purity CO₂ to the chamber 100, and a circulation line 130 that recovers and recycles the CO₂ discharged from the chamber 100 and again supplies the CO₂ to the chamber 100.

The chamber 100 is a high-pressure container. The chamber 100 includes a stage 101. The stage 101 is a ring-shaped flat plate holding a substrate W to be treated thereon.

The supply line 110 includes a cylinder 111, a boosting pump 112, a heater 115, and valves 117 and 118.

The cylinder 111 stores liquid-state high purity (new) carbon dioxide. The carbon dioxide contains the IPA in a concentration of 1 ppm or less.

The boosting pump 112 forcibly makes carbon dioxide leave from the cylinder 111 via a pipe line 113 and discharges the carbon dioxide outside thereof by raising the pressure. The boosting pump 112 raises the pressure of the carbon dioxide up to a pressure equal to or higher than its critical pressure. The carbon dioxide discharged from the boosting pump 112 is supplied to the heater 115 via the pipe line 114.

The heater 115 raises (heats) the temperature of the carbon dioxide to a temperature equal to or higher than its critical temperature. Then, the carbon dioxide enters its supercritical state.

The carbon dioxide (supercritical CO₂) discharged in its supercritical state from the heater 115 is supplied to the chamber 100 via a pipe line 116. The supercritical CO₂ is high in its purity and contains the IPA in a concentration of 1 ppm or less, since the supercritical CO₂ is based on the high-purity (new) carbon dioxide in the cylinder 111. Hereinafter, the supercritical CO₂ fluid based on the high-purity (new) carbon dioxide in the cylinder 111 is called supercritical high-purity CO₂.

The pipe line 116 is provided with valves 117 and 118. The amount of supercritical high-purity CO₂ supplied to the chamber 100 can be adjusted according to the open degree of the valve 117. The valve 118 is opened when the supercritical high-purity CO₂ is supplied to the chamber 100, whereas the valve 118 is closed when the supercritical high-purity CO₂ is not supplied to the chamber 100 (in this case, the supercritical recycled CO₂ is supplied to the chamber 100 via the circulation line 130 described below).

The pipe lines 113, 114, and 116 are provided with filters 121, 122, and 123, respectively, to remove particles.

The circulation line 130 includes valves 132, 145, and 146, a gas-liquid separator 133, a heat exchanger 135, an adsorption tower 136, a cooler 138, a tank 139, and boosting pumps 141 and a heater 143.

The gas or the supercritical fluid inside the chamber 100 is discharged via a pipe line 131. Since the pipe line 131 is provided with a pressure control valve 132, the supercritical fluid turns into a gas on the downstream side of the valve 132 of the pipe line 131.

The gas-liquid separator 133 separates a gas from a liquid. For example, when the supercritical CO₂ fluid in which the IPA is dissolved is discharged from the chamber 100, the gas-liquid separator 133 separates the liquid IPA from the gaseous carbon dioxide. The separated IPA can be reused after it is subjected to removal of the dissolved CO₂ or the moisture.

The carbon dioxide discharged being in the gas state from the gas-liquid separator 133 is supplied to the adsorption tower 136 via the pipe line 134. The pipe line 134 is provided with the heat exchanger 135 to prevent the carbon dioxide from becoming dry ice. As for the carbon dioxide containing a small amount of IPA, the IPA is adsorbed to the adsorption tower 136 and thus is removed.

The adsorption tower 136 removes the IPA remaining in the carbon dioxide. The adsorption tower 136 has, for example, zeolite therein.

The carbon dioxide passing through the adsorption tower 136 is supplied to the tank 139 via the pipe line 137. The pipe line 137 is provided with the cooler 138 that cools the carbon dioxide. The cooled (liquid) carbon dioxide is stored in the tank 139. Accordingly, the carbon dioxide discharged from the chamber 100 is recycled by a recycling unit that includes the gas-liquid separator 133, the heat exchanger 135, the adsorption tower 136, and the cooler 138, and then is stored in the tank 139.

The IPA is removed from the carbon dioxide to some extent by the gas-liquid separator 133 or the adsorption tower 136, but is not completely removed. The concentration of the IPA in the recycled carbon dioxide stored in the tank 139 is in the range from about 10 ppm to about 100 ppm.

The boosting pump 141 sucks the recycled carbon dioxide from the tank 139 via the pipe line 140 and discharges the carbon dioxide by raising the pressure. The boosting pump 141 raises the pressure of the carbon dioxide to a pressure equal to or higher than its critical pressure. The recycled carbon dioxide discharged from the boosting pump 141 is supplied to the heater 143 via the pipe line 142.

The heater 143 raises (heats) the temperature of the recycled carbon dioxide to a temperature equal to or higher than its critical temperature. Thus, the recycled carbon dioxide enters the supercritical state. Hereinafter, the supercritical CO₂ fluid based on the recycled carbon dioxide in the tank 139 is called supercritical recycled CO₂.

The supercritical recycled CO₂ discharged from the heater 143 is supplied to the chamber 100 via the pipe line 144. Since the supercritical recycled CO₂ is based on the recycled carbon dioxide in the tank 139, the purity of the supercritical recycled CO₂ is lower than that of the supercritical high-purity CO₂ supplied to the chamber 100 via the supply line 110 and the IPA concentration of the supercritical recycled CO₂ is in the range from about 10 ppm to 100 ppm.

The pipe line 144 is provided with valves 145 and 146. The amount of supercritical recycled CO₂ supplied to the chamber 100 can be adjusted according to the open degree of the valve 145. The valve 146 is opened when the supercritical recycled CO₂ is supplied to the chamber 100, whereas the valve 146 is closed when the supercritical recycled CO₂ is not supplied to the chamber 100 (in this case, the supercritical high-purity CO₂ is supplied to the chamber 100 via the supply line 110).

The pipe lines 140, 142, and 144 are provided with filters 151, 152, and 153, respectively, to remove particles. Each valve may be controlled to be opened or closed by a controller (not shown).

The supercritical drying system is configured to supply the supercritical high-purity CO₂ to the chamber 100 or supply the supercritical recycled CO₂ to the chamber 100.

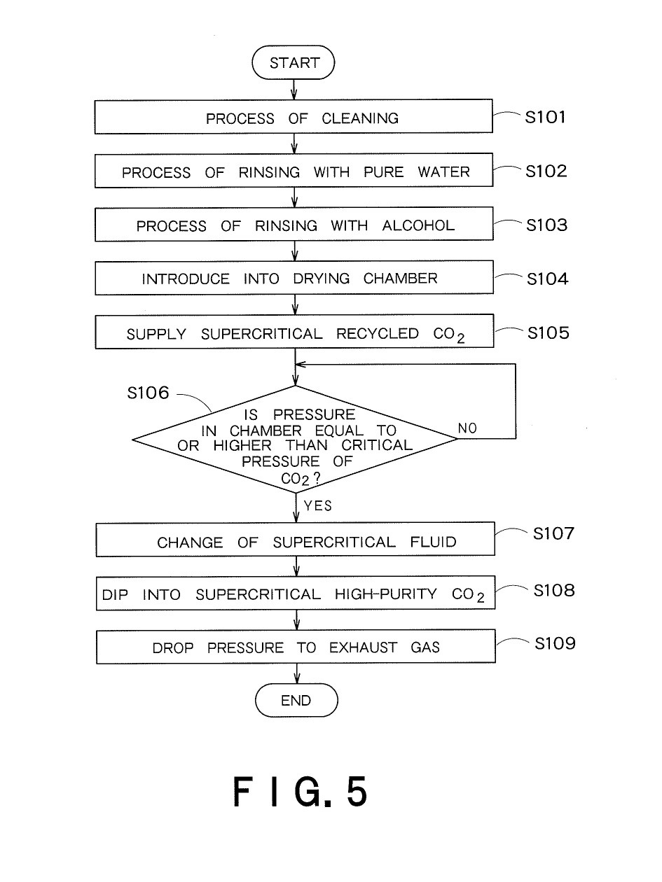

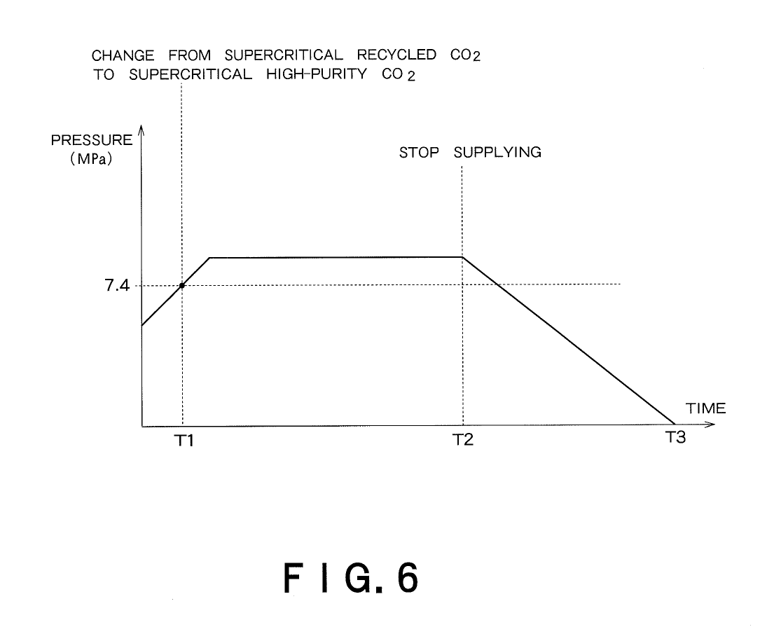

Next, methods of cleaning and drying a semiconductor substrate, by supercritical drying, according to this embodiment will be described with reference to the flowchart of FIG. 5 and the graph of FIG. 6. The supercritical drying is performed using the supercritical drying system shown in FIG. 4.

In step S101, a semiconductor substrate to be processed is introduced into a cleaning chamber (not shown). Then, cleaning is performed by supplying a chemical liquid to the surface of the semiconductor substrate. Examples of the chemical liquid include sulfuric acid, hydrofluoric acid, hydrochloric acid, hydrogen peroxide, and ammonia.

Here, the cleaning treatment includes peeling resist from the semiconductor substrate, removing particles or metallic impurities, and removing a film formed on the semiconductor substrate by etching.

In step S102, after the cleaning, pure water rinsing is performed by supplying pure water to the surface of the semiconductor substrate to rinse the chemical liquid remaining on the surface of the semiconductor substrate with the pure water.

In step S103, after the pure water rinsing, alcohol rinsing is performed by supplying alcohol to the surface of the semiconductor substrate to replace the pure water remaining on the surface of the semiconductor substrate with the alcohol. As the alcohol, ones that can be dissolved in (easily displaced with) both the pure water and the supercritical CO₂ are used. In this embodiment, isopropyl alcohol (IPA) is used.

In step S104, after the alcohol rinsing, the semiconductor substrate is taken out of the cleaning chamber in the state where the surface of the semiconductor substrate is wet with the IPA as not to be dried naturally. Then, the semiconductor substrate is introduced into the chamber 100 of the supercritical drying system shown in FIG. 4 and is fixed to the stage 101.

In step S105, the pressure and temperature of the recycled carbon dioxide stored in the tank 139 are increased by the boosting pump 141 and the heater 143. Then, the recycled carbon dioxide turns into the supercritical fluid and is supplied to the chamber 100 via the pipe line 144. At this time, the valve 118 is closed and the valve 146 is opened.

Then, the valve 132 is opened so that the supercritical fluid with the dissolved IPA is gradually discharged from the chamber 100 via the pipe line 131 while the supercritical recycled CO₂ is being supplied to the chamber 100 via the pipe line 144. The carbon dioxide with the dissolved IPA discharged from the chamber 100 is recovered, recycled, and reused through the circulation line 130.

When the recycled carbon dioxide is not stored in the tank 139 such as the time of an initial operation of the supercritical drying system, the supercritical fluid is supplied to the chamber 100 using the carbon dioxide in the cylinder 111. Thereafter, when the recycled carbon dioxide is stored to some extent in the tank 139, the recycled carbon dioxide is supplied as the supercritical recycled CO₂ to the chamber 100.

In step S106, when the pressure inside the chamber 100 is equal to or higher than 7.4 MPa (critical pressure), the process proceeds to step S107.

In step S107, the valve 118 is opened and the valve 146 is closed (time T1 of FIG. 6). The pressure and temperature of the high-purity carbon dioxide stored in the cylinder 111 are increased by the boosting pump 112 and the heater 115. Then, the high-purity carbon dioxide is changed to the supercritical fluid and is supplied to the chamber 100 via the pipe line 116. Thus, the supercritical fluid supplied to the chamber 100 is changed from the supercritical recycled CO₂ to the supercritical high-purity CO₂.

In step S108, the semiconductor substrate is dipped into the supercritical high-purity CO₂ for a predetermined time such as about 20 minutes. Then, the IPA on the semiconductor substrate is dissolved in the supercritical fluid, the IPA is removed from the semiconductor substrate, and the semiconductor substrate is dried.

At this time, the valve 132 is opened so that the supercritical fluid with the dissolved IPA is gradually discharged from the chamber 100 via the pipe line 131, while the supercritical high-purity CO₂ is supplied to the chamber 100 via the pipe line 116.

In step S109, the valve 117 is closed so that the supply of the supercritical high-purity CO₂ is stopped, and then the valve 132 is opened so that the pressure inside the chamber 100 drops to the atmospheric pressure (time T2 to time T3 of FIG. 6). Thus, the carbon dioxide inside the chamber 100 is changed to the gaseous state. The carbon dioxide inside the chamber 100 is discharged (purged) in a gaseous state from the chamber 100. In this way, the drying of the semiconductor substrate is completed. However, since the IPA dissolved in the supercritical fluid is in the liquid phase, the IPA is maintained in a cluster (mist) state during the supercritical state. However, when the pressure of the IPA drops to a pressure equal to or lower than the critical pressure of the carbonate supercritical state, the IPA remaining inside the chamber 100 condenses and drops on the semiconductor substrate. Then, the IPA turns into particles and remains on the semiconductor substrate. Accordingly, in order to reduce the particles generated due to the IPA, the IPA mist in the carbonate supercritical state has to be effectively discharged from the chamber 100 and the IPA concentration inside the chamber 100 has to be controlled so as to be reduced.

In this embodiment, when the pressure inside the chamber 100 is lower than the critical pressure of the carbon dioxide (before time T1 of FIG. 6), the supercritical fluid based on the recycled carbon dioxide is used to evacuate the inside of the chamber 100. Therefore, cost can be reduced, as compared with the case in which (new) carbon dioxide in the cylinder 111 is used from the initial step.

When the pressure inside the chamber 100 is equal to or higher than the critical pressure of carbon dioxide, the supercritical fluid supplied to the chamber 100 is changed from the supercritical recycled CO₂ to the supercritical high-purity CO₂, and then the IPA is purged from the chamber 100 using the supercritical high-purity CO₂. Therefore, when the pressure inside the chamber 100 drops in step S109, as in FIG. 3(a), the IPA concentration inside the chamber 100 considerably decreases, resulting in reduction in the number of particles attributable to the IPA on the semiconductor substrate.

As the circulation line 130, it is satisfactory as long as it is capable of controlling the IPA concentration of carbon dioxide so as to be in the range from about 10 ppm to about 100 ppm. That is, apparatus cost can be reduced because high performance in removing the IPA is not required.

As described above, according to this embodiment, the carbon dioxide can be recovered, recycled, and reused and the number of particles generated on the semiconductor substrate can be reduced.

In this embodiment, when the pressure inside the chamber 100 reaches the critical pressure of carbon dioxide, the supercritical fluid supplied to the chamber 100 is changed from the supercritical recycled CO₂ to the supercritical high-purity CO₂. However, the time of such change may come earlier or later than that. When the time of change comes earlier, the use amount of (new) carbon dioxide inside the cylinder 111 increases somewhat. However, since the IPA concentration inside the chamber 100 can be further lowered, it is possible to further reduce the number of particles generated due to the IPA on the semiconductor substrate. On the other hand, when the time of change comes later, the number of particles generated due to the IPA on the semiconductor substrate increases somewhat. However, since the use amount of (new) carbon dioxide in the cylinder 111 can be further reduced, which reduces the cost.

### Second Embodiment

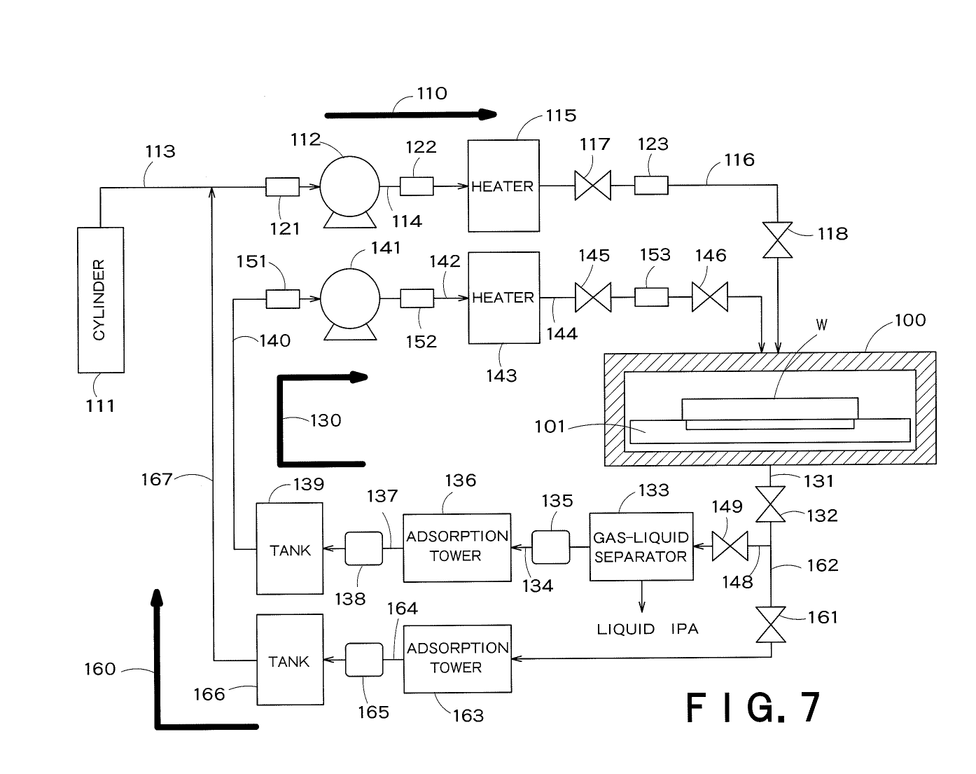

FIG. 7 is a schematic diagram illustrating the outline of a supercritical drying system according to a second embodiment of the invention. In this embodiment, the configuration is the same as that of the first embodiment shown in FIG. 4 except that a recovery and recycling line 160 is installed, the pipe line 131 is divided into a pipe line 148 serving as a circulation line 130 and a pipe line 162 serving as a recovery and recycling line 160 on the downstream side of the valve 132, and the pipe line 148 is provided with a valve 149. In FIG. 7, like elements as in the first embodiment shown in FIG. 4 are denoted with like reference numerals, and the description thereof will not be repeated.

The recovery and recycling line 160 recovers and recycles CO₂ discharged from a chamber 100 and causes the recycled CO₂ to flow through the supply line 110. The recovery and recycling line 160 includes a valve 161, an adsorption tower 163, a cooler 165, and a tank 166.

The CO₂ discharged from the chamber 100 is supplied to the adsorption tower 163 via the pipe lines 131 and 162. The pipe line 162 is provided with the valve 161. The valve 161 is opened when the valve 149 is closed, whereas the valve 161 is closed when the valve 149 is opened. Accordingly, the CO₂ discharged from the chamber 100 is configured to flow to one of the circulation line 130 and the recovery and recycling line 160.

Specifically, when it is considered that the IPA concentration of the CO₂ discharged from the chamber 100 is high (for example, 100 ppm or more), the discharged CO₂ is configured to flow to the circulation line 130. In contrast, when it is considered that the IPA concentration of the CO₂ discharged from the chamber 100 is low (for example, less than 100 ppm), the discharged CO₂ is configured to flow to the recovery and recycling line 160.

The adsorption tower 163 removes the IPA remaining in the carbon dioxide. The adsorption tower 163 has, for example, zeolite therein.

The carbon dioxide passing through the adsorption tower 163 is supplied to the tank 166 via the pipe line 164. The pipe line 164 is provided with the cooler 165 that cools the carbon dioxide. The cooled (liquid) carbon dioxide is stored in the tank 166. Accordingly, the carbon dioxide discharged from the chamber 100 is recycled by a recycling unit that includes the adsorption tower 163 and the cooler 165, and then is stored in the tank 166.

Since the carbon dioxide containing IPA in a low concentration is supplied to the recovery and recycling line 160, most of the IPA is removed when the adsorption tower 163 removes the IPA, so that the IPA concentration of recycled carbon dioxide stored in the tank 166 is 1 ppm or less.

A pipe line 167 of the recovery and recycling line 160 is connected to the pipe line 113 of the supply line 110. The boosting pump 112 sucks the recycled high-purity carbon dioxide from the tank 166 via the pipe line 167 and discharges the carbon dioxide by raising the pressure. Whether the boosting pump 112 sucks the carbon dioxide in the cylinder 111 or the carbon dioxide in the tank 166 is controlled by a valve or the like (not shown). Hereinafter, the supercritical fluid based on the recycled high-purity carbon dioxide in the tank 166 is called supercritical recycled high-purity CO₂.

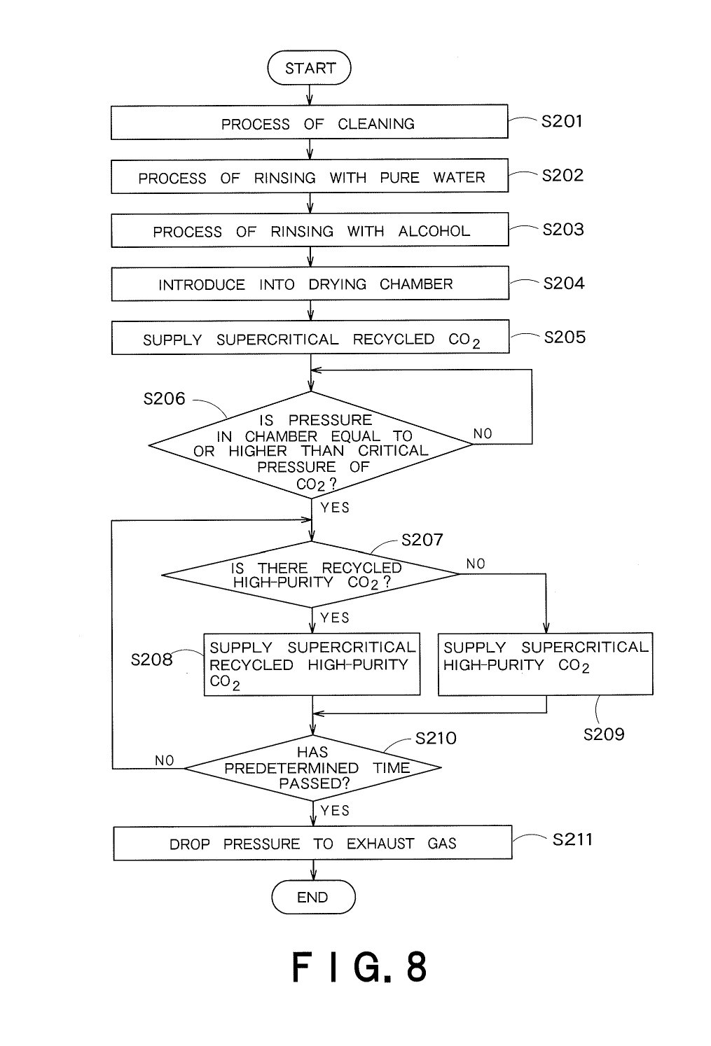

Next, method of cleaning and supercritical drying a semiconductor substrate using a supercritical drying system will be described with reference to FIG. 8. Since step S201 to step S206 are the same as step S101 to step S106 in FIG. 5, the description thereof will not be repeated.

In step S207, when there is the recycled high-purity carbon dioxide in the tank 166, the process proceeds to step S208. On the other hand, when there is no recycled high-purity carbon dioxide, the process proceeds to step S209.

In step S208, the valve 118 is opened and the valve 146 is closed. The pressure and temperature of the recycled high-purity carbon dioxide stored in the tank 166 are increased by the boosting pump 112 and the heater 115. Then, the recycled high-purity carbon dioxide is changed into the supercritical fluid and is supplied to the chamber 100 via the pipe line 116. Thus, the supercritical fluid supplied to the chamber 100 is changed from the supercritical recycled CO₂ to the supercritical high-purity CO₂.

At this time, the valve 132 is opened so that the supercritical fluid with the dissolved IPA therein is gradually discharged from the chamber 100 via the pipe line 131, while the supercritical recycled high-purity CO₂ is supplied to the chamber 100 via the pipe line 116.

In step S209, the valve 118 is opened and the valve 146 is closed. The pressure and temperature of the high-purity carbon dioxide stored in the cylinder 111 are increased by the boosting pump 112 and the heater 115. Then, the high-purity carbon dioxide is changed into the supercritical fluid and is supplied to the chamber 100 via the pipe line 116. Thus, the supercritical fluid supplied to the chamber 100 is changed from the supercritical CO₂ to the supercritical high-purity CO₂.

At this time, the valve 132 is opened so that the supercritical fluid containing the dissolved IPA is gradually discharged from the chamber 100 via the pipe line 131, while the supercritical high-purity CO₂ is supplied to the chamber 100 via the pipe line 116.

The discharging destination of the carbon dioxide in the chamber 100 is the circulation line 130 until step S206, but the discharging destination of the carbon dioxide is the recovery and recycling line 160 after step S207. The carbon dioxide discharged from the chamber 100 is supplied to the recovery and recycling line 160 by closing the valve 149 and opening the valve 161.

The discharging destination of the carbon dioxide in the chamber 100 may be switched when the supercritical fluid supplied to the chamber 100 is changed from the supercritical recycled high-purity CO₂ to the supercritical high-purity CO₂ or the supercritical recycled high-purity CO₂ or when a predetermined time has passed since the change of the supercritical fluid.

In step S210, when the semiconductor substrate is dipped into the supercritical recycled high-purity CO₂ or the supercritical high-purity CO₂ and then the predetermined time such as 20 minutes has passed, the process proceeds to step S211. On the other hand, if the predetermined time has not passed, the process returns to step S207.

The IPA on the semiconductor substrate is dissolved by dipping the semiconductor substrate into the supercritical recycled high-purity CO₂ or the supercritical high-purity CO₂ for a predetermined time, so the IPA is removed from the semiconductor substrate and the semiconductor substrate is dried.

In step S211, the supply of the supercritical recycled high-purity CO₂ or the supercritical high-purity CO₂ is stopped by closing the valve 117 and the valve 132 is opened, so that the pressure inside the chamber 100 drops and returns to the atmospheric pressure. Thus, the carbon dioxide and the IPA inside the chamber 100 are turned into the gaseous state. The carbon dioxide and the IPA inside the chamber 100 are discharged in the gaseous state from the chamber 100. Thus, drying the semiconductor substrate ends.

Thus, in this embodiment, when the pressure inside the chamber 100 is lower than the critical pressure of the carbon dioxide, the IPA is purged from the chamber 100 using the supercritical fluid based on the recycled carbon dioxide. Therefore, cost can be reduced, as compared with the case in which (new) carbon dioxide in the cylinder 111 is used from the initial step.

Moreover, the recovery and recycling line 160 recovers and recycles the carbon dioxide with a low IPA concentration which is discharged from the chamber 100 and generates the recycled high-purity carbon dioxide. Since the usage amount of (new) carbon dioxide of the cylinder 111 can be further reduced by using the supercritical recycled high-purity CO₂ based on the recycled high-purity carbon dioxide, the cost can be reduced.

On the other hand, when the pressure inside the chamber 100 is equal to or higher than the critical pressure of the carbon dioxide, the supercritical fluid supplied to the chamber 100 is changed from the supercritical recycled CO₂ to the supercritical recycled high-purity CO₂ or the supercritical high-purity CO₂ and then the IPA is purged from the chamber 100 using the supercritical recycled high-purity CO₂ or the supercritical high-purity CO₂. Therefore, when the pressure inside the chamber 100 is dropped in step S213, as in the state of FIG. 3(a), the IPA concentration inside the chamber 100 considerably decreases, so that the number of particles generated due to the IPA on the semiconductor substrate decreases to be small.

In this embodiment, the carbon dioxide can be recovered, recycled, and reused, while the number of particles generated on the semiconductor substrate decreases.

In the second embodiment, the recovery and recycling line 160 is connected to the supply line 110. However, the recovery and recycling line 160 may not be connected to the supply line 110 and the recovery and recycling line 160 may be provided with a boosting pump or a heater so that the supercritical fluid based on the recycled high-purity carbon dioxide may be supplied to the chamber 100.

### First Modification of First and Second Embodiments

In the first and second embodiments, when the pressure inside the chamber 100 reaches the critical pressure of the carbon dioxide, the supercritical fluid supplied to the chamber 100 is changed from the recycled CO₂ to the supercritical high-purity CO₂ (the supercritical recycled high-purity CO₂). However, the change timing may be determined based on the amount of IPA introduced into the chamber 100, that is, the amount of IPA piled on a wafer (processed substrate W).

For example, the supercritical fluid is changed to the supercritical high-purity CO₂ (the supercritical recycled high-purity CO₂) when the IPA on the wafer is dissolved in the supercritical fluid and the IPA on the surface of the wafer disappears.

According to an experiment, it is known that the IPA of about 50 cc is dissolved in the supercritical fluid for 1 minute when the wafer with 300 mm is under 40° C. and 8 MPa. For example, on the assumption that the height of a liquid level of the IPA piled on the wafer is 1 mm, the IPA of about 70 cc is introduced into the chamber 100 and it takes about 1 minute 30 seconds to dissolve the IPA in the supercritical fluid.

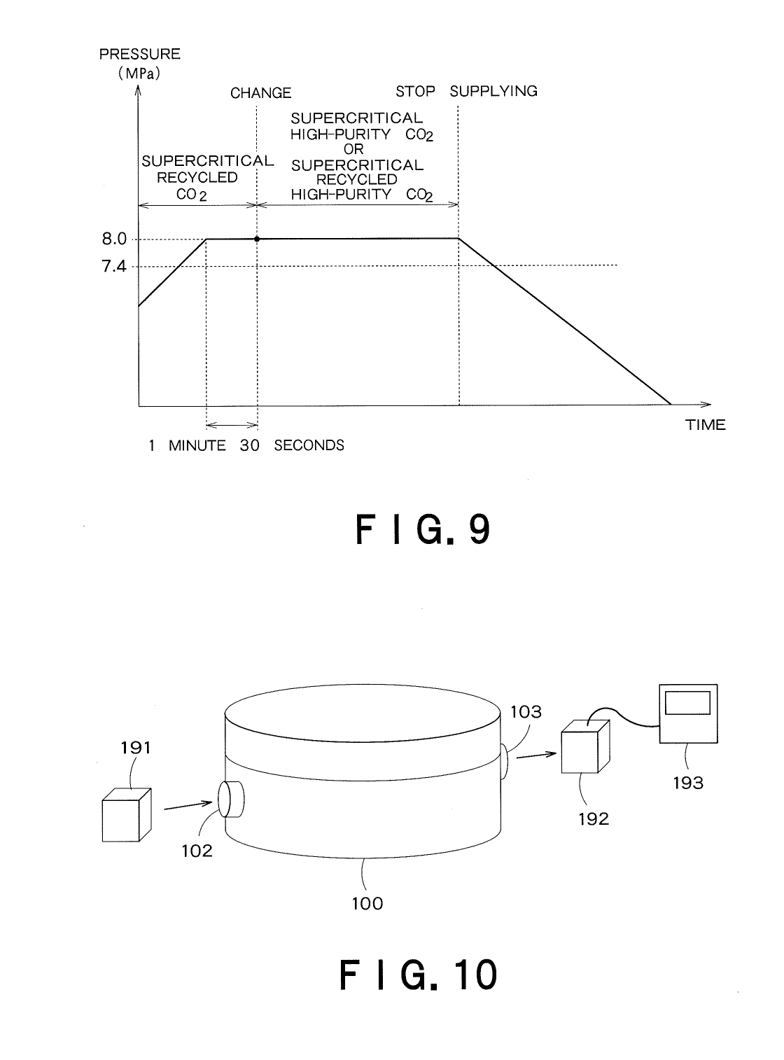

When the pressure becomes 8 MPa inside the chamber 100, 1 minute 30 second passes, and then the IPA disappears from the surface of the wafer, as shown in FIG. 9, the supercritical fluid is changed to the supercritical high-purity CO₂ (the supercritical recycled high-purity CO₂).

Thus, the change timing may be determined based on the amount of IPA introduced into the chamber 100 by beforehand calculating the speed at which the IPA is dissolved in the supercritical fluid by an experiment.

### Second Modification of First and Second Embodiments

In the first and second embodiments, when the pressure inside the chamber 100 reaches the critical pressure of the carbon dioxide, the supercritical fluid supplied to the chamber 100 is changed from the recycled CO₂ to the supercritical high-purity CO₂ (the supercritical recycled high-purity CO₂). However, the change timing may be determined based on the amount of recovered liquid IPA separated by the gas-liquid separator 133.

For example, a liquid level sensor may be provided to detect the liquid level of the liquid IPA separated by the gas-liquid separator 133 or a weight sensor may be provided to detect the weight of the liquid IPA. By monitoring the detection result of the liquid level sensor or the weight sensor, the supercritical fluid is changed when there is no variation in the detection result.

Thus, the change timing may be determined based on the variation in amount of recovered liquid IPA.

### Third Modification of First and Second Embodiments

In the first and second embodiments, when the pressure inside the chamber 100 reaches the critical pressure of the carbon dioxide, the supercritical fluid supplied to the chamber 100 is changed from the recycled CO₂ to the supercritical high-purity CO₂ (the supercritical recycled high-purity CO₂). The spectroscopic characteristics inside the chamber 100 may be detected using a supercritical spectroscopic cell, and the change timing may be determined based on the variation in the spectroscopic characteristics.

As sown in FIG. 10, for example, the supercritical spectroscopic cell includes a light source 191, a light-receiving unit 192, and a calculation unit 193. A pair of windows 102 and 103 is installed in the chamber 100. The light source 191 emits radiation light by diffusing light according to the wavelength of the radiation light. The light emitted from the light source 191 enters the chamber 100 through the window 102 and is received by the light-receiving 192 through the window 103 according to the wavelength. The light-receiving unit 192 performs photoelectric conversion to output an electric signal to the calculation unit 193. The calculation unit 193 obtains the spectroscopic characteristics based on the electric signal.

When the discharging of the IPA from the chamber 100 is verified from the variation in the spectroscopic characteristics by monitoring the spectroscopic characteristics obtained by the calculation unit 193, the supercritical fluid is changed.

Thus, the change timing may be determined based on the variation in spectroscopic characteristics inside the chamber 100.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A supercritical drying method comprising:
introducing a semiconductor substrate of which a surface is wet with a supercritical displacement solvent into a chamber;
supplying a first supercritical fluid being based on first carbon dioxide to the chamber;
supplying a second supercritical fluid, which is based on second carbon dioxide containing no supercritical displacement solvent or containing the supercritical displacement solvent in a concentration lower than that in the first carbon dioxide, to the chamber, after the supplying of the first supercritical fluid;
lowering an inside pressure of the chamber to gasify the second supercritical fluid and to discharge the gasified second supercritical fluid from the chamber; and
recovering and recycling the carbon dioxide discharged from the chamber.

2. The supercritical drying method according to claim 1,
wherein the carbon dioxide discharged from the chamber is recovered and then recycled as the first carbon dioxide.

3. The supercritical drying method according to claim 2,
wherein the carbon dioxide discharged from the chamber is recovered and recycled as the first carbon dioxide while the first supercritical fluid is supplied to the chamber, and
the carbon dioxide discharged from the chamber is recovered and recycled as the second carbon dioxide, while the second supercritical fluid is supplied to the chamber.

4. The supercritical drying method according to claim 1,
wherein the first supercritical fluid is supplied to the chamber when the inside pressure of the chamber is lower than a critical pressure of the carbon dioxide, and
the second supercritical fluid is supplied to the chamber when the inside pressure of the chamber is equal to or higher than the critical pressure of the carbon dioxide.

5. The supercritical drying method according to claim 1,
wherein, the first supercritical fluid is supplied to the chamber when the inside pressure of the chamber reaches a predetermined value and when a time based on an amount of supercritical displacement solvent on the semiconductor substrate has not passed, whereas the second supercritical fluid is supplied to the chamber when the time has passed.

6. The supercritical drying method according to claim 1,
wherein the recycling of the carbon dioxide discharged from the chamber as the first carbon dioxide comprises separating and recovering the supercritical displacement solvent from the carbon dioxide by a gas-liquid separator, and
based on a variation in an amount of recovered supercritical displacement solvent, a timing is determined at which the supercritical fluid supplied to the chamber is changed from the first supercritical fluid to the second supercritical fluid.

7. The supercritical drying method according to claim 1,
wherein a spectroscopic characteristic inside the chamber is obtained, and
based on a variation in the spectroscopic characteristic, a timing is determined at which the supercritical fluid supplied to the chamber is changed from the first supercritical fluid to the second supercritical fluid.

8. The supercritical drying method according to claim 1, further comprising: before the introducing of the semiconductor substrate into the chamber,
cleaning the semiconductor substrate using a chemical liquid;
rinsing the semiconductor substrate using pure water, after the cleaning of the semiconductor substrate; and
rinsing the semiconductor substrate using alcohol serving as the supercritical displacement solvent, after the rinsing of the semiconductor substrate using the pure water.

9. The supercritical drying method according to claim 1,
wherein the supercritical displacement solvent is a substance formed from a material selected from a group consisting of alcohols (lower alcohol or higher alcohol), fluorinated alcohol, chlorofluorocarbon (CFC), hydrofluorocarbon (HCFC), hydrofluoroether (HFE), perfluoro carbon (PFC), halogenated aldehydes, halogenated ketones, halogenated diketones, halogenated esters, and halogenated silanes.

10. A supercritical drying system comprising:
a chamber configured to dry a semiconductor substrate being wet with a supercritical displacement solvent therein;
a first storage unit which stores first carbon dioxide;
a first pump that sucks the first carbon dioxide from the first storage unit and boosts and outputs the first carbon dioxide;
a first heater that heats the first carbon dioxide output from the first pump so that the first carbon dioxide turns into a first supercritical fluid;
a first pipe line that guides the first supercritical fluid to the chamber;
a first valve that is installed in the first pipe line to adjust an amount of the first supercritical fluid to be supplied to the chamber;
a recycling unit that recycles carbon dioxide discharged from the chamber and supplies the recycled carbon dioxide to the first storage unit;
a second storage unit that stores second carbon dioxide which contains no supercritical displacement solvent or contains the supercritical displacement solvent in a concentration lower than that of the first carbon dioxide;
a second pump that sucks the second carbon dioxide from the second storage unit and boosts and outputs the second carbon dioxide;
a second heater that heats the second carbon dioxide output from the second pump so that the second carbon dioxide turns into a second supercritical fluid;
a second pipe line that guides the second supercritical fluid to the chamber; and
a second valve that is installed in the second pipe line to adjust an amount of the second supercritical fluid to be supplied to the chamber.

11. The supercritical drying system according to claim 10, further comprising:
a third storage unit that stores third carbon dioxide containing the supercritical displacement solvent in a concentration lower than that of the first carbon dioxide and higher than that of the second carbon dioxide; and
a second recycling unit that recycles the carbon dioxide discharged from the chamber and supplies the discharged carbon dioxide to the third storage unit,
wherein the second pump sucks the third carbon dioxide from the third storage unit and boosts and outputs the third carbon dioxide, the second heater heats the third carbon dioxide output from the second pump so that the third carbon dioxide turns into a third supercritical fluid, and the second pipe line guides the third supercritical fluid to the chamber, and
the first recycling unit recycles the carbon dioxide discharged from the chamber when the first valve is opened and the second valve is closed, whereas the second recycling unit recycles the carbon dioxide discharged from the chamber when the second valve is opened and the first valve is closed.

12. The supercritical drying system according to claim 10, further comprising:
a light source that emits light;
a light-receiving unit that receives the light, performs photoelectric conversion, and outputs an electric signal; and
a calculation unit that obtains a spectroscopic characteristic based on the electric signal,
wherein the light emitted from the light source enters the chamber through a first window installed in the chamber,
the light-receiving unit receives the light having passed through the chamber through a second window installed in the chamber, and
opening and closing of the first and second valves are controlled based on a variation in the spectroscopic characteristic.

13. The supercritical drying system according to claim 10,
wherein the supercritical displacement solvent is a substance formed from a material selected from a group consisting of alcohols (lower alcohol or higher alcohol), fluorinated alcohol, chlorofluorocarbon (CFC), hydrofluorocarbon (HCFC), hydrofluoroether (HFE), perfluoro carbon (PFC), halogenated aldehydes, halogenated ketones, halogenated diketones, halogenated esters, and halogenated silanes.
